(19) United States
(12) Patent Application Publication
(10) Pub. No.: US 2008/0123588 A1
(43) Pub. Date: May 29, 2008

(54) WIRELESS COMMUNICATION METHOD AND APPARATUS FOR PROVIDING NETWORK ADVICE TO MOBILE STATIONS

(75) Inventors: Marian Rudolf, Montreal (CA); Joseph A. Kwak, Bolingbrook, IL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/736,646

(22) Filed: Apr. 18, 2007

Related U.S. Application Data
(60) Provisional application No. 60/793,890, filed on Apr. 21, 2006.

(51) Int. Cl. H04Q 7/00

(52) U.S. Cl. 370/329

(57) ABSTRACT

A wireless communication method and apparatus for providing network advice to wireless transmit/receive units (WTRUs) are disclosed. Once start-up of a WTRU is initiated, the WTRU scans a network advice channel in a particular band, (e.g., 5.180 GHz-5.320 GHz). If a network advice frame is detected, the WTRU tunes to a channel indicated by the network advice frame and associates with a basic service set (BSS) operating on the channel indicated by the network advice frame. Otherwise, the WTRU scans another available network advice channel in the band.

### CROSS REFERENCE TO RELATED APPLICATION

This application claims the benefit of U.S. Provisional Application No. 60/793,890 filed Apr. 21, 2006, which is incorporated by reference as if fully set forth.

### FIELD OF INVENTION

The present invention relates to providing information in a wireless communication system. More particularly, the present invention relates to a wireless communication method and apparatus for providing network advice (NA) to wireless transmit/receive units (WTRUs), (i.e., mobile stations (STAs)).

### BACKGROUND

Wireless fidelity (WiFi) refers to certain types of wireless local area networks (WLAN) that use specifications conforming to IEEE 802.11b. WiFi has gained acceptance in many environments as an alternative to a wired LAN. Many airports, hotels, and other services offer public access to WiFi networks so people can log onto the Internet and receive emails on the move. These locations are known as hotspots.

Currently, a WTRU, (e.g., a WiFi STA), must search for an available access point (AP) to establish WiFi services. This search involves scanning, (i.e., searching), WiFi channels passively (by listening) or actively (by transmitting a Probe Request frame) in order to detect the presence of an AP in an established basic service set (BSS). When a WTRU is first powered on, (and in other situations generally), the WTRU may not be aware of its geographical location and, therefore will not be aware of the defined regulatory class for its current location. The current country code and regulatory class are elements transmitted in beacons by an AP to inform all WTRUs of channel (frequency) and power restrictions which are properties of each regulatory class. Without such knowledge, a WTRU must scan all defined channels in its operating frequency range.

There are 14 channels defined in the 2.4 GHz band, and 42 channels defined in the 5.0 GHz band. Each of these channels must be sequentially scanned to detect the presence of a BSS for service. If no BSS is detected after a complete scan, the process is repeated after some delay. If a BSS is detected, the WTRU attempts to associate to initiate WiFi services. If the WTRU is traveling in an area that is not covered by WiFi, this scanning process continues indefinitely. Scanning all channels continuously in this way consumes a significant amount of power and, in addition, results in a significant start-up delay from the user's perspective.

### SUMMARY

The present invention is related to a wireless communication method and apparatus for providing network advice to WTRUs. Once start-up of a WTRU is initiated, the WTRU scans a network advice channel in a particular band, (e.g., 5.180 GHz-5.320 GHz). If a network advice frame is detected, the WTRU tunes to a channel indicated by the network advice frame and associates with a basic service set (BSS) operating on the channel indicated by the network advice frame. Otherwise, the WTRU scans another available network advice channel in the band.

### BRIEF DESCRIPTION OF THE DRAWINGS

The foregoing summary, as well as the following detailed description of the preferred embodiments of the present invention will be better understood when read with reference to the appended drawings, wherein:

FIG. 1 shows an example of bands scanned by an IEEE 802.11a or IEEE 802.11n WTRU looking for a BSS to associate with in accordance with the present invention;

FIG. 2 is a flow diagram of a NA process in accordance with the present invention; and

FIG. 3 is a block diagram of a WTRU which is configured to implement the NA process of FIG. 2.

### DETAILED DESCRIPTION OF THE PREFERRED EMBODIMENTS

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node-B, site controller, access point or any other type of interfacing device in a wireless environment.

Although the present invention is described using examples associated with WiFi and IEEE 802, one skilled in the art would understand that the present invention may be incorporated into any type of wireless communication system.

Power would be saved and battery life for client devices extended if a more efficient means to scan for an available wireless communication service, such as WiFi, existed. WiFi hotspots are relatively rare in the world at this time. This is primarily due to the maturity and wide proliferation of cellular technology compared to WiFi; 90% of the continental United States is covered by cellular while perhaps only one percent of the continental United States is covered by WiFi. The limited coverage of WiFi is also due to the reduced radio range of IEEE 802.11b/g/ and IEEE 802.11a (WiFi) technology compared to today's cellular networks.

However, going forward it is expected that the proliferation of dual mode cellular/WiFi handsets on the market will greatly increase. These handsets target voice over Internet protocol (VoIP) service on WiFi as a lower cost alternative to cellular. WiFi may also be preferred for its higher data rates or other reasons. As such, WiFi may be the preferred mode of operation for these handsets and these battery operated devices will constantly be scanning for WiFi networks for potential service. This scanning operation is very costly in terms of power and start-up time. Each possible channel for the band in use needs to be passively or actively scanned on a pseudo-continuous basis until a suitable BSS for services is detected. As an added complication, more and more spectrum for unlicensed service such as WiFi is freed up in various regulatory domains, particularly in the 5 GHz band, resulting in an ever-increasing number of channels and channel settings to be scanned by a client device. The scan operation to detect presence of WiFi access points (APs) in an area today already accounts as the most important factor of reduced battery life for a WiFi handset. Therefore, better methods and solutions to increase the battery life of WiFi client devices, (i.e., WTRUs), simultaneously permit quick detection of present APs in an area while keeping battery consumption as low as possible are desired.

Network advice (NA) frames carry information for providing a short signal on at least one pre-assigned unlicensed national information infrastructure (UNII) channel in each WiFi band (regulatory class). For example, WiFi bands in wide-spread use today in North America and Europe are either 2.4 GHz or 5 GHz bands. Some regulatory domains such as Japan provide WiFi Service also in the 4.9 GHz band.

An NA frame indicates that there is an active basic service set (BSS) available in the area and provides, as a minimum, the channel (frequency) used by that BSS. Thus, the NA frame may include BSS identification information and other data used to assist a WTRU to decide to join an available BSS. In this way, WTRUs, (i.e., handsets), looking for initial network entry need not scan all available channels in the band, but only a few of the available channels to determine if there are any BSSs in that band. A signal including an NA frame may be provided by any NA capable WTRU which is operating in any BSS in that band. The obligation of transmitting such a signal including the NA frame is shared among all NA WTRUs in that band. Since the NA frame is not defined for legacy terminals, this approach is compatible with legacy terminal operation.

When NA frames are implemented, a WTRU only needs to scan the pre-assigned channels for all regulatory classes for its band of operation. An efficient implementation of NA frames would use a single channel (1 of 14) in the 2.4 GHz band, and up to 8 channels (8 of 42) in the 5.0 GHz band to determine if any BSSs are operating in that area. This results in significant power savings and start-up time reductions. In one particular example, the pre-assigned NA channel within the 2.4 GHz band could simply be channel 1. Instead of scanning through all channels 1-14 at start-up, the WTRU would first look into channel 1, extract advertised information about WiFi networks present in this area on the available channels and then directly tune-in to one selected channel.

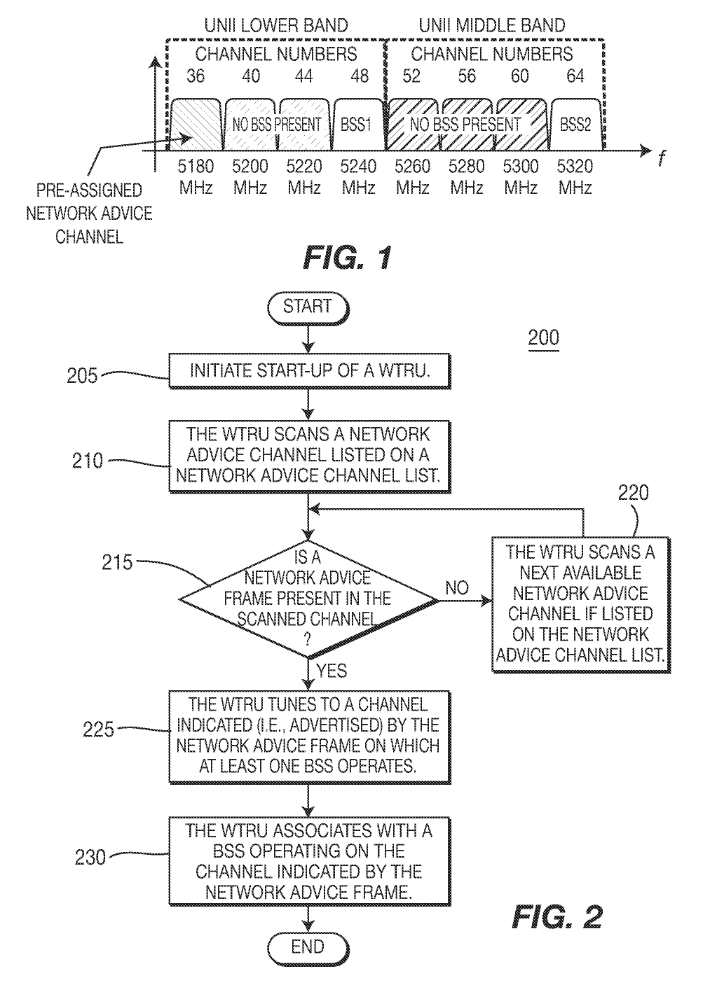

FIG. 1 shows an example of bands, (5.180-5.320 GHz), scanned by an IEEE 802.11a or IEEE 802.11n WTRU looking for a BSS to associate with in accordance with the present invention. Note that, in this example, but without loss of generality by the present invention, the NA frames are sent by other devices present in the area via a pre-assigned channel 36. NA frames on the pre-assigned channel 36 can be sent either by WTRUs, or by APs, or by a combination of the two. A resolution protocol is described which results in assignments of certain WTRUs, APs or a combination of the two to advertise the presence of the BSS operating on the pre-assigned channel. Methods are described to configure or assign channels on the client side and/or on the network side. In an alternative embodiment of the present invention, the radio signal is modified to allow for faster and less power-consuming detection through the client radio frequency (RF) front-end, as opposed to full RF and baseband (BB) on for the purpose of scanning.

The pre-assigned channels, valid for either a single WiFi band or for more than one WiFi band, are hereafter referred to as NA channels. NA channels refer to at least one known pre-assigned channel, valid for at least one band.

In one embodiment, WiFi standards or other de facto methods are used to establish a fixed set of agreed upon NA channels. There is at least one NA channel to be used for NA transmissions in each regulatory class. These NA channels are programmed into a database internal to the client or network device. At start-up or when scanning is triggered by internal logic, the device consults this internal database, extracts the NA channels and tunes to one of the NA channels.

FIG. 2 shows a WTRU procedure 200 in accordance with the present invention. In step 205, the start-up of a WTRU is initiated. In step 210, the WTRU scans an NA channel listed on a NA channel list. If, in step 215, an NA frame is not detected in the NA channel, the WTRU scans a next available network advice channel in the band if listed on the NA channel list (step 220). If all of the NA channels on the list are scanned without detecting an NA frame, the WTRU may wait for a predetermined period of time to expire before scanning the NA channels on the list again. Alternatively, NA channels on the NA channel list may be individually scanned between predetermined wait periods.

Still referring to FIG. 2, if an NA frame is detected in step 215, the WTRU tunes to a channel indicated, (i.e., advertised), by the NA frame on which at least one BSS operates (step 225). In step 230, the WTRU then associates with a BSS operating on the channel indicated by the NA frame.

In case of a network device such as an AP, the database can be implemented on a remote network server or device reachable through the network and can be retrieved remotely at start-up or at certain time instants during system operation.

In an additional embodiment, the NA channels, for at least one band are pushed from the WiFi, cellular or other network into the client device. At WTRU start-up, even if the client device needs to go through a full channel scan by not having a list of NA channels available, the WTRU downloads a list of NA channels for subsequent usage. For example, the WTRU may download the NA channel list via an Ethernet connection, (before the user leaves home and travels somewhere), or a network could automatically provide the NA channel list to the WTRU in response to an event, based on a predetermined criteria, and/or on a periodic basis.

In another embodiment, the list of NA channels is combined with location information. A client device equipped with location determination logic can check its location, and then selectively extract the NA channels valid for a particular location or area.

A client device upon start-up, after determining the NA channels as described, tunes to one of the NA channels and checks for the presence of an operating BSS or the presence of at least one NA frame. If it receives such an NA frame, it extracts information pertaining to the presence of BSSs, or more generally WiFi (or other) networks in this area, such as channel number, BSS identification, configuration and service information, and tunes to the channel indicated, (i.e., advertised), by the NA frame. If no BSS or NA frame is found, then the WTRU attempts reception on the next NA channel, or, if none is left, stops scanning.

In accordance with the present invention, WTRUs are provided with the responsibility for transmitting the NA frame on one or more NA channels. In one embodiment, WiFi network attached devices, such as APs, preferably take on this role, because ideally, they are not-battery powered. In yet another embodiment, WTRUs take on the responsibility of sending NA frames on one or more NA channels at certain intermittent time instants. Also, a combination of above two methods where a combination of client devices and network devices transmit the NA frames can be used.

Either one particular device is assigned to transmit NA frames on the NA channel, or the responsibility is assigned to more than one device. In the latter case, several possible assignment schemes may be used, for example round robin, fixed and pre-assigned, random selection, or the like.

An assigned WTRU, while operating in the BSS on its home channel, will periodically switch to the NA channel for the BSS regulatory class, and will transmit a NA frame containing the home channel number and other information such as, for example, information about other channels than its own home channel and about detected or present WiFi networks.

In one embodiment of the present invention, an NA control scheme is used to pass responsibility for transmitting the NA frames from a current WTRU to another WTRU at the end of the NA interval. The NA transmission process continues indefinitely or for a pre-determined amount of time. Responsibility is passed, for example, by frame exchange between the WTRU currently transmitting NA frames, and the next assigned WTRU to transmit NA frames. Alternatively, assignment of responsibility for transmission of NA frames may be established by an AP or other assignment authority. Alternatively, these assignment frame exchanges could include additional information transmitted in the NA frame, a list of last known WTRUs assigned responsibility to transmit NA frames, timer values, and the like.

The NA control scheme may also permit selective favoring of one device class over another when designating NA transmission responsibility. For instance, an AP may choose not to assign NA responsibility to WTRUs using battery power. Also, an AP may choose to provide all NA transmissions itself. This aspect of the control scheme may involve exchange of NA capabilities between an AP and a WTRU upon association, and control by the AP of WTRU network advice functions. The control scheme may further be used to provide NA on more than one channel in each regulatory class. In the extreme, NA frames may be provided on all channels not in use by a BSS. This approach would be useful where there are no pre-assigned NA channels or where roaming WTRUs may be unaware of the pre-assigned NA channels in use.

One example of an implementation may include NA frame contents: country (3 octets), regulatory class (1 octet), BSS channel (1 octet), current TxID (1 octet), next TxID (1 octet) and timing (2 octets), for a total of 9 octets. Country and regulatory class are the same as in the beacon for the BSS of the WTRU transmitting the NA. The BSS Channel is the current operating channel of the BSS of the WTRU transmitting the NA frame. The current TxID is the identifier for the WTRU transmitting the NA, and is the lowest 8 bits of the WTRU's medium access control (MAC) address. (One exception is when the lowest 8 bits are all 0, 1 is used instead.) The next TxID is the identifying number for the next WTRU to transmit NA frames for the next NA interval, the value 0 indicates that no WTRU has yet been assigned. (The frame exchange between the current Tx WTRU and the next Tx WTRU takes place during the current NA interval to designate next WTRU and time for next WTRU to take over NA transmissions.) The timing field consists of two subfields: NA interval, (4 bits, 10 second units), and next start time, (12 bits, 50 msec units, decrementing with each transmission).

In an alternative embodiment, the RF signal transmitted with or in the NA frame by WiFi devices is modified to allow faster activity detection through radio frequency (RF) by a scanning device. In this case, an easy to detect RF NA signal, preferably but not limited to power-level threshold detection, is transmitted into one or more NA channels by devices. Alternatively, the method can be used even if there is no NA channel on the band by directly transmitting the RF NA signal on the channel used by a WiFi network. With this approach, a scanning device doesn't need full RF and BB processing to find out about the presence of a WiFi network. Instead, the scanning device uses a simplified RF detection process, such as envelope or peak detection, or correlation, to quickly determine activity in the channel. If such activity is detected, the full RF and BB demodulation is switched on and the device in the next step tries to associate with the WiFi network.

One example is a single or a group of NA assigned sub-carrier tones such as used by orthogonal frequency division multiplexing (OFDM) as in IEEE 802.11a/g/n. Another example is a direct-sequence code sent at low power into the channel or overlaid over the regular transmission.

In one preferred embodiment, the RF NA signal is realized through modulating a set of OFDM pilot tones with a known or fixed sequence, or through transmitting the tones at a high power level.

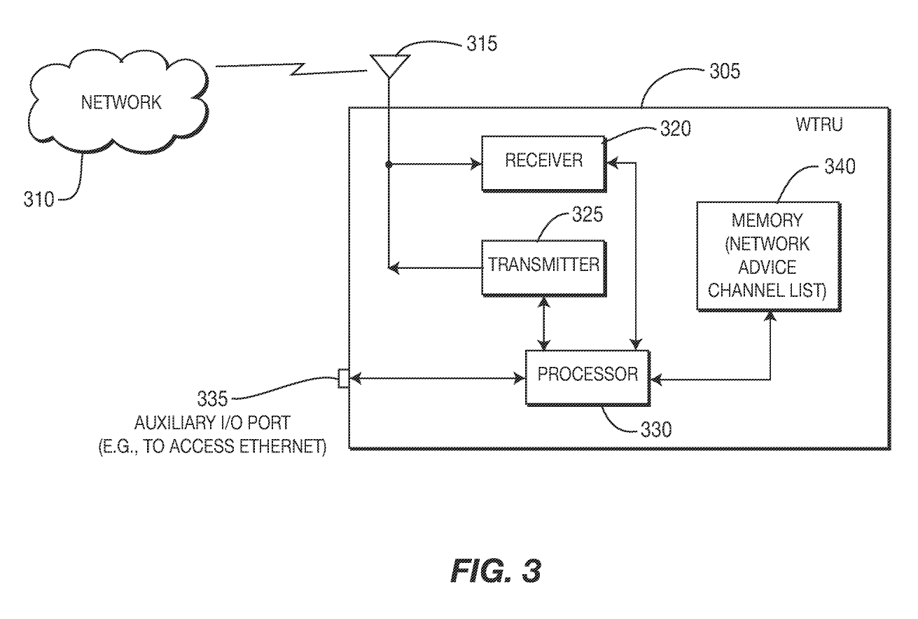

FIG. 3 is a block diagram of a WTRU 305 in communication with a network 310. The WTRU 305 includes an antenna 315, a receiver 320, a transmitter 325, a processor 330, an auxiliary input/output (I/O) port 335 and a memory 340. The processor 330 analyzes NA frames to determine whether to instruct the transmitter 325 and receiver 320 to change channels indicated by the NA frames. The WTRU 305 communicates with the network 310 via the antenna 315.

A network advice channel list may be downloaded by the WTRU 305 into the memory 340 via the auxiliary I/O port 335 via an Ethernet connection, or by receiving downloaded information from the network 310 via the antenna 315 and the receiver 320.

The processor 330 is responsible for initiating start-up of the WTRU 305 and controlling the receiver 320 to scan NA channels and determine whether an NA frame is present in the scanned channel. If an NA frame is not present, the processor 330 instructs the receiver to scan other channels on a sequential basis. If more than one channel is indicated by the NA frame, the processor 330 determines which channel the receiver 320 should tune to first based on a predetermined criteria. If more than one BSS is advertised on a channel indicated by an NA frame, the processor 330 determines which BSS to associate with based on a predetermined criteria.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless communication method for providing network advice to a wireless transmit/receiver unit (WTRU), the method comprising:
scanning a network advice channel listed on a network advice channel list;
detecting a network advice frame in the network advice channel that indicates a channel;
tuning to the channel indicated by the network advice frame; and
associating with a basic service set (BSS) operating on the channel indicated by the network advice frame.

2. The method of claim 1 wherein the network advice frame is a short signal on a pre-assigned channel in a WiFi band.

3. The method of claim 1 wherein the network advice channel operates in a 2.4 GHz, 4.9 GHz or 5.0 GHz band.

4. The method of claim 1 wherein the network advice frame indicates whether there is an active BSS available in the area and provides the channel used by the BSS.

5. The method of claim 1 wherein the network advice frame includes BSS identification information.

6. The method of claim 1 wherein a pre-assigned channel is scanned for all regulatory classes for its operation band.

7. The method of claim 1 wherein a single channel is utilized in a 2.4 GHz band to determine if any BSSs are operating.

8. The method of claim 1 wherein up to 8 channels are utilized in a 5.0 GHz band to determine if any BSS are operating.

9. The method of claim 1 wherein the network advice channel is a single scanned channel in a 2.4 GHz band that includes advertised information about WiFi networks present in the area on available channels.

10. The method of claim 1 wherein the network advice frame is transmitted by another WTRU.

11. The method of claim 1 wherein the network advice frame is transmitted by an access point (AP).

12. The method of claim 12 further comprising using a resolution protocol for assigning certain WTRUs, APs, or a combination of WTRUs and APs, to advertise the presence of a BSS operating on a pre-assigned channel.

13. The method of claim 1 further comprising downloading the network advice channel list to the WTRU.

14. A wireless transmit/receive unit (WTRU) in communication with the network, the WTRU comprising:
a memory configured to store a network advice channel list;
a receiver configured to scan a network advice channel listed on the network advice channel list, detect a network advice frame in the network advice channel that indicates a channel, and tune to the channel indicated by the network advice frame; and
a processor electrically coupled to the memory and the receiver, the processor being configured to associate with a basic service set (BSS) operating on the channel indicated by the network advice frame.

15. The system of claim 14 wherein the network advice frame is a short signal on a pre-assigned channel in a WiFi band.

16. The system of claim 14 wherein the network advice channel operates in a 2.4 GHz, 4.9 GHz or 5.0 GHz band.

17. The system of claim 14 wherein the network advice frame indicates whether there is an active BSS available in the area and provides the channel used by the BSS.

18. The system of claim 14 wherein the network advice frame includes BSS identification information.

19. The system of claim 14 wherein a pre-assigned channel is scanned for all regulatory classes for its operation band.

20. The system of claim 14 wherein a single channel is utilized in a 2.4 GHz band to determine if any BSSs are operating.

21. The system of claim 14 wherein up to 8 channels are utilized in a 5.0 GHz band to determine if any BSS are operating.

22. The system of claim 14 wherein the network advice channel is a single scanned channel in a 2.4 GHz band that includes advertised information about WiFi networks present in the area on available channels.

23. The system of claim 14 wherein the network advice frame is transmitted by another WTRU.

24. The system of claim 14 wherein the network advice frame is transmitted by an access point (AP).

25. The system of claim 24 wherein a resolution protocol is used for assigning certain WTRUs, APs, or a combination of WTRUs and APs, to advertise the presence of a BSS operating on a pre-assigned channel.

26. The system of claim 25 wherein the WTRU further comprises an auxiliary input/output (I/O) port for accessing an Ethernet connection to download the network advice channel list.

27. A wireless transmit/receive unit (WTRU) comprising:
a memory configured to store a network advice channel list;
a receiver in communication with the antenna, the receiver configured to scan a network advice channel listed on the network advice channel list for a network advice frame; and
a processor configured to control the receiver to scan another network advice channel if a network advice frame is not detected, and associate with a basic service set (BSS) operating on a channel indicated by a detected network advice frame.
